(19) United States
(12) Patent Application Publication
(10) Pub. No.: US 2010/0123363 A1
(43) Pub. Date: May 20, 2010

(54) METHOD OF PREVENTING CORROSION IN A PUMP MOTOR FOR A DISHWASHER, AND ASSOCIATED APPARATUS

(75) Inventors: Dennis A. Poyner, Kinston, NC (US); Jeffrey E. Nelson, Kinston, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/272,379

(22) Filed: Nov. 17, 2008

(51) Int. Cl. H02K 3/44

(52) U.S. Cl. 310/179

(57) ABSTRACT

A method of preventing galvanic corrosion in a pump motor for a dishwashing appliance is provided, wherein the dishwashing appliance includes a tub portion and a sump assembly disposed about a lower end of the tub portion for receiving a dishwashing fluid therein. Such a method comprises operably engaging a pump assembly in fluid communication with the sump assembly. The pump assembly has a pump motor with a non-submersed aluminum winding terminating in and secured to at least one non-aluminum metallic electrical connector about a non-submersed interface. A moisture-resistant coating material is applied about the non-submersed interface between the aluminum winding and the non-aluminum metallic electrical connector, so as to prevent moisture from encroaching into the interface and promoting galvanic corrosion between the dissimilar metals of the winding and the at least one electrical connector. An associated apparatus is also provided.

### BACKGROUND OF THE INVENTION

1. Field of the Invention

Embodiments of the present invention relate to washing appliances and, more particularly, to a method of preventing corrosion in a pump motor for a dishwashing appliance, and an apparatus associated therewith.

2. Description of Related Art

One manner of improving a dishwasher design is to reduce the costs of components, while retaining or improving functionality and service life. In this regard, electric motors typically used by dishwashers for circulation pump and/or drain pump functions are often constructed using copper windings. Due to increased costs of copper materials, however, it may be desirable to implement other suitable alternatives. One alternative configuration may implement a less expensive aluminum winding for the electric motor, in place of the common copper winding. One issue that may be encountered, though, is that the electric motor typically includes one or more electrical terminals engaged with the winding, and the one or more electrical terminals are often not comprised of aluminum (i.e., a brass material). In such instances, the aluminum winding in contact with the non-aluminum terminal(s) may result in a potential difference at the engagement therebetween. Accordingly, because of the moist/humid environment often associated with a dishwasher, an undesirable risk of galvanic corrosion exists at or about the engagement between the electrical terminals and the aluminum winding, due to the moisture penetrating or otherwise encroaching into the contact area therebetween, which could significantly shorten the service life of the motor. That is, moisture encroachment between the dissimilar metals of the terminal/winding may result in the initiation of galvanic corrosion, particularly when the potential difference between the materials is high, with the risk of causing an open circuit within the motor. More particularly, incidences of premature failure of the motor may increase, particularly, for example, where the aluminum winding engages brass electrical terminals, due to galvanic corrosion. Such corrosion may cause, for example, intermittent or complete motor failure, as well as undesirably high temperatures about the engagement between the winding and the terminals during motor operation.

Accordingly, there exists a need for a method and apparatus for preventing galvanic corrosion between dissimilar materials at the winding-terminal junction in a pump motor in a dishwasher where, for example, the motor implements an alternative material, such as aluminum, for the motor winding.

### BRIEF SUMMARY OF THE INVENTION

The above and other needs are met by the present invention which, according to one aspect, provides a method of preventing galvanic corrosion in a pump motor for a dishwasher having a tub portion adapted to contain washing fluid therein, wherein the dishwasher further includes a sump assembly disposed about a lower end of the tub portion for receiving the washing fluid therefrom. Such a the method comprises operably engaging a pump assembly in fluid communication with the sump assembly, wherein the pump assembly has a pump motor with a non-submersed winding terminating in and secured to at least one electrical connector about a non-submersed interface, and wherein the winding comprises a first metallic material and the electrical connector comprises a second metallic material different from the first metallic material. A coating material is applied about the non-submersed interface between the winding and the electrical connector, so as to cover the securement therebetween, and to prevent moisture from encroaching between the winding and the electrical connector and promoting galvanic corrosion between the dissimilar first and second metallic materials thereof.

Another aspect of the present invention provides a dishwasher, comprising a tub portion having a lower end and being adapted to contain a washing fluid therein. A sump assembly is disposed about the lower end of the tub portion for receiving the washing fluid therefrom. A pump assembly is in fluid communication with the sump assembly. The pump assembly includes a pump motor with a non-submersed winding terminating in and secured to at least one electrical connector about a non-submersed interface, wherein the winding comprises a first metallic material and the electrical connector comprises a second metallic material different from the first metallic material. The pump assembly further includes a coating material disposed about the non-submersed interface between the winding and the electrical connector, so as to cover the securement therebetween, and to prevent moisture from encroaching between the winding and the electrical connector and promoting galvanic corrosion between the dissimilar first and second metallic materials thereof.

Yet another aspect of the present invention provides a pump assembly, comprising a pump motor with a non-submersible winding terminating in and secured to at least one electrical connector about a non-submersible interface, wherein the winding comprises a first metallic material and the electrical connector comprises a second metallic material different from the first metallic material. A coating material is disposed about the non-submersible interface between the winding and the electrical connector, so as to cover the securement therebetween, and to prevent moisture from encroaching between the winding and the electrical connector and promoting galvanic corrosion between the dissimilar first and second metallic materials thereof.

Embodiments of the present invention thus provide advantages as otherwise detailed herein.

### BRIEF DESCRIPTION OF THE SEVERAL VIEWS OF THE DRAWINGS

Having thus described various embodiments of the invention in general terms, reference will now be made to accompanying drawings, which are not necessarily drawn to scale, and wherein:

FIG. 1 is a perspective view of a dishwasher capable of implementing various embodiments of the present disclosure;

FIG. 2 illustrates winding wires extending into and through a coating material applied about the engagement between winding and electrical connectors associated with a pump motor, according to one embodiment of the present invention;

FIG. 3 illustrates a top view of a coating material covering winding-terminal junctions of a pump motor for a dishwasher, according to one embodiment of the present invention; and

FIG. 4 is a perspective view illustrating electrical connectors and a main motor stack of a pump motor for a dishwasher, with a coating material covering winding-terminal junctions (with one uncovered junction).

### DETAILED DESCRIPTION OF THE EMBODIMENTS OF THE INVENTION

The present disclosure now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

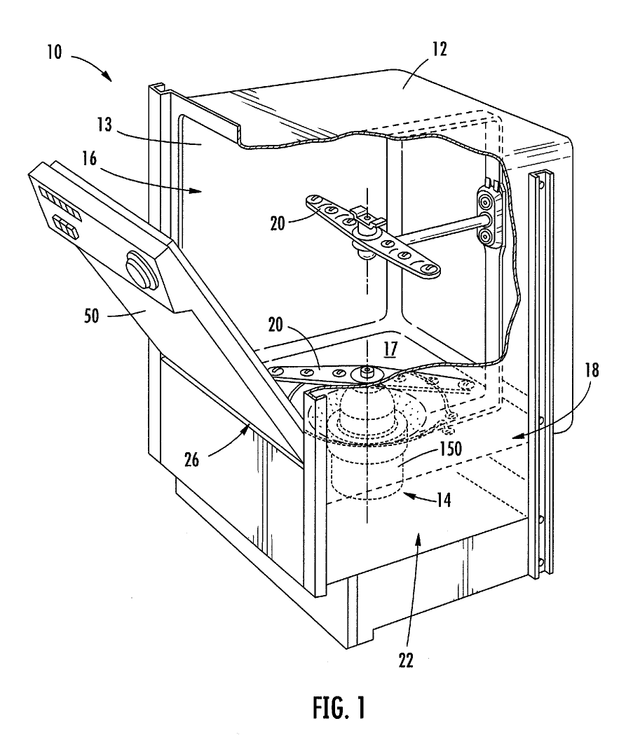

FIG. 1 illustrates one example of a dishwashing appliance, such as a dishwasher 10, capable of implementing various embodiments of the present invention. Such a dishwasher 10 typically includes a tub portion 12 (partly broken away in FIG. 1 to show internal details) having a plurality of walls (e.g., side wall 13) for forming an enclosure in which dishes, utensils, and other dishware may be placed for washing. The tub portion 12 may also define a forward access opening, generally designated as 16. As known in the art, the dishwasher 10 may also include slidable lower and upper racks (not shown) for holding the dishes, utensils, and dishware to be washed. A door assembly 50 may be pivotably engaged with the tub portion 12 about the lower end 18 thereof so as to selectively permit access to the interior of the tub portion 12. That is, a lower edge 26 of the door assembly 50 may be pivotably engaged (i.e., hinged) with the lower end 18 of the tub portion 12 such that the door assembly 50 is pivotable about the lower edge 26 to provide access to the interior of the tub portion 12 through the forward access opening 16, and to cover and seal the forward access opening 16 when the dishwasher 10 is in operation.

The tub portion 12 may further define or have engaged therewith a sump (or sump assembly), generally designated as 14, in which wash water or rinse water is collected, typically under the influence of gravity. The sump 14 may cooperate with a bottom wall 17 of the tub portion 12 to form the lower end 18 of the tub portion 12, wherein the bottom wall 17 may be sloped to direct washing fluid toward the sump 14. The wash/rinse water may be pumped/recirculated by a circulation pump 150 out of the sump 14 to various spray arms 20 mounted in the interior of the tub portion 12 for spraying the wash/rinse water, under pressure, onto the dishes, utensils, and other dishware contained therein. Further, a drain system may be connected to or otherwise in fluid communication with the sump 14 for removing the dishwashing fluid from the dishwasher 10 via a house drain, wherein the drain system may include a drain pump configured to pump dishwashing fluid to the house drain line. The drain pump and the circulation pump may be driven by separate electric motors engaged therewith though, in some instances, a single electric motor may drive both the drain pump and the circulation pump.

The operational components (e.g., circulation pump, drain pump, water valve) of the dishwasher 10 may be housed, disposed, or otherwise positioned within a base portion/component 22 beneath the tub portion 12, wherein the base portion 22 receives and supports the lower end 18 of the tub portion 12. In some instances, the base portion 22 may be a separate component with respect to the tub portion 12, such as, for example, a molded polymer component, while in other instances, the base portion 22 may be integral with the tub portion 12 such that the side walls forming the tub portion 12 also at least partially form the base portion 22.

The pumps (e.g., drain pump, circulation pump) associated with the dishwasher 10 may each comprise a pump assembly having a pump body or housing, wherein a pump mechanism, such as, for example, an impeller member, is disposed in the pump body. The pump mechanism may be driven by a pump motor, generally designated as 100, engaged therewith, for pumping the water from the pump body or housing through the dishwasher hydraulic system (in the case of the circulation pump) or for pumping the water out of the pump housing or body and from the dishwasher 10 toward the house drain line (in the case of the drain pump). In some instances, the pump mechanism may be received by a corresponding volute defined by the pump body/housing. The pump mechanism, such as the impeller member, is at least partially submersed in water within the volute such that, during operation, the impeller member interacts with the water within the volute to pump the water from the pump housing/body, so that the pump assembly functions in the desired manner (i.e., re-circulating the water or draining the water).

The pump motor 100 may comprise an armature member having a main motor stack 102 such as, for example, a plurality of thin metal plates stacked together, which may be secured to a structure 104. Further, the pump motor 100 may include an armature winding 110, comprised of a first metallic material such as, for example, a copper or aluminum wire, wound, coiled, or otherwise wrapped about certain portions of the armature member, as will be understood by one of skill in the art. Further, once wound about the armature member, the ends of the winding 110 may be in electrical communication with and secured to one or more electrical connectors or terminals 120, comprised of a second metallic material such as, for example, brass electrical terminals. The terminals 120 may be operably engaged with the structure 104, which provides reinforcement and support therefor. More particularly, for example, the winding 110 may have a first end 112 soldered (i.e., as illustrated by the solder bump 130) to one electrical connector 120, such that an electrical current can move therebetween at the interface/terminal junction, generally designated as 140, formed between the winding 110 and electrical connector 120. In this manner, the first end 112 of the winding 110 may be secured to or otherwise engaged with the electrical connector 120 so as to be in electrical engagement therewith. A plurality of electrical connectors may be associated with the pump motor 100, wherein each electrical connector has an end of a winding 110 operably engaged therewith. In any instance, according to embodiments of the present invention, the winding 110, as well as the interface/terminal junction 140 between the winding 110 and the electrical connector 120, is configured so as to be not submersed in water or other liquid. However, the interface/terminal junction 140 may ordinarily be at risk of moisture encroachment into the contact area between the winding 110 and the electrical connector or terminal 120, due to the high humidity conditions often encountered due to the operational nature of the dishwasher 10.

In some instances, the electrical connector 120 may be configured to be in electrical communication with a power source (not shown), for example, through an interaction between a male connector and a complementary corresponding female connector, so as to complete the electrical circuit associated with the pump motor 100. In other instances, the power source may be otherwise secured to the electrical connectors 120 so as to be in electrical communication therewith. Of course, the electrical connector may also be wired into the overall wiring scheme of the dishwasher 10 and, in some instances, may be wired such that the pump assembly is controlled by a controller (not shown) configured to direct operation of various dishwasher components.

As mentioned previously, electric pump motors typically used by dishwashers for circulation pump and/or drain pump functions are often constructed using copper windings and brass electrical terminals. Such copper windings may, in some instances, increase the overall cost of constructing the dishwasher 10. As such, embodiments of the present invention may implement electric pump motors constructed using windings comprised of suitable alternative materials, such as, for example, aluminum, which may have one advantage in reducing the cost of the motor 100. However, such alternatives may comprise materials that may be electrically dissimilar from the material forming the electrical connectors/terminals. In such instances, the moist/humid environment associated with the dishwasher 10, to which the interface/terminal junction 140 may be exposed, can lead to an increased risk of galvanic corrosion thereabout.

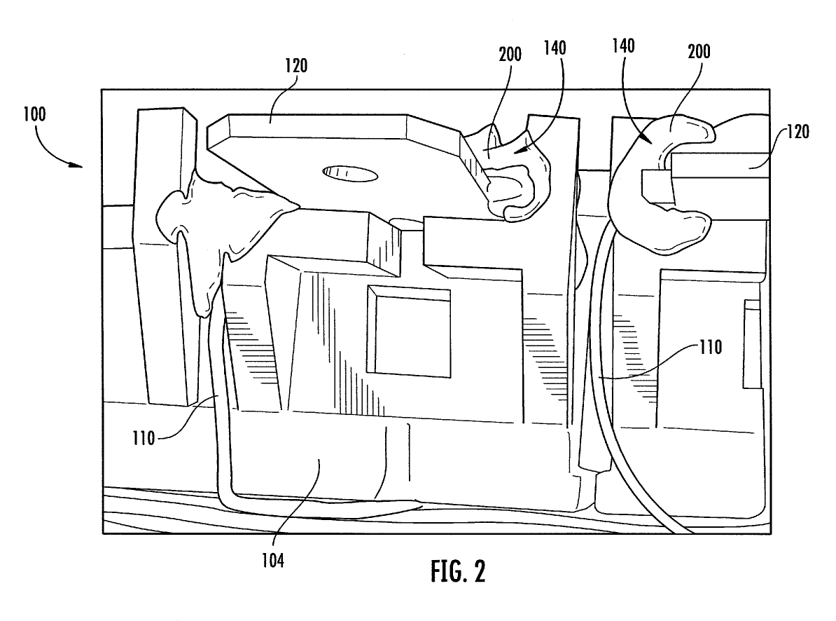

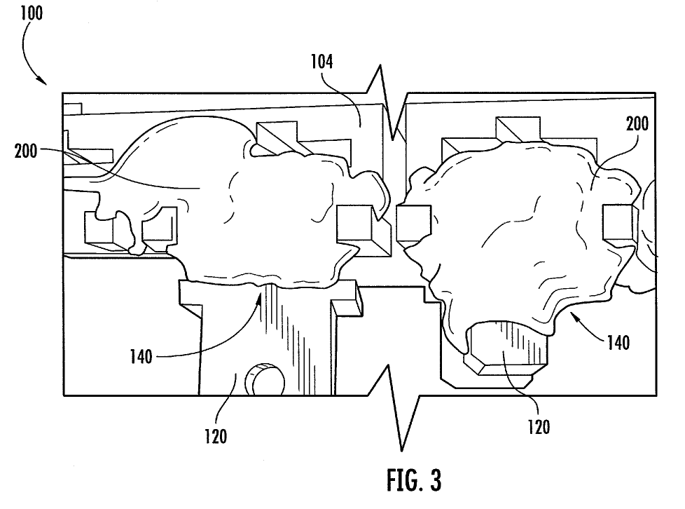

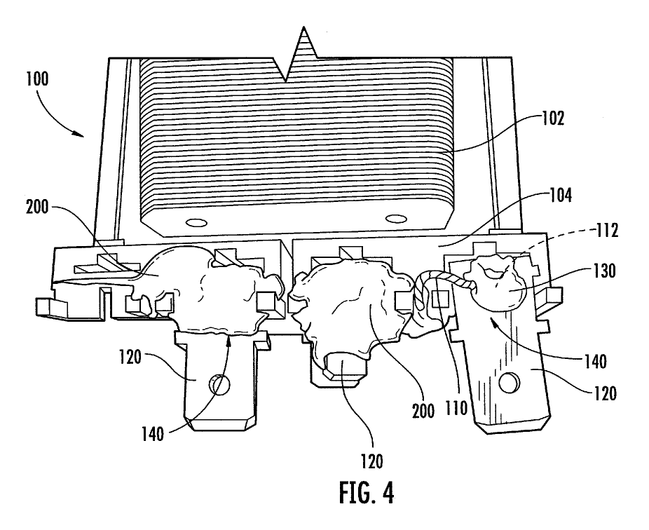

In accordance with embodiments of the present disclosure, with reference to FIGS. 2-4, the dishwasher 10 may thus include a modified pump motor 100 configured to prevent galvanic corrosion between the winding 110 and the electrical connector 120. In such instances, the pump motor 100 may further comprise a suitable coating material 200 configured to coat or otherwise substantially encompass the interface/terminal junction 140 for preventing moisture encroachment between the dissimilar metals (i.e., the aluminum winding 110 and the brass electrical terminal 120). Coating the interface/terminal junction 140 thus prevents moisture encroachment into the contact area between the winding and the terminal (i.e., isolates the engagement between the dissimilar metals), wherein such moisture encroachment could normally initiate galvanic corrosion. In this regard, a coating material 200 may be provided at and about the interface/terminal junction 140 between the winding 110 and the electrical connector 120, wherein the coating material 200 substantially encompasses the interface/terminal junction 140. In one particular example, the coating material 200 may be coated over the interface/terminal junction 140 formed between an aluminum winding and a non-aluminum electrical connector such as, for example, a brass electrical terminal. Of course, the coating material may be applied to interfaces formed between other windings 110 and other electrical connectors 120 in which a dissimilar metallic material couple is present, wherein the engagement (contact area) therebetween may normally be susceptible to galvanic corrosion.

In one instance, the coating material 200 may be a V-0 flammability rated, UL approved (listed or recognized), and moisture resistant epoxy material or sealant material applied across and substantially about the engagement between the aluminum winding 110 and the brass terminals 120 of the motor assembly. Further, the coating material 200, such as, for example, an epoxy material or a sealant material, may also be configured to resist ignition and arc-tracking that can be caused by contaminates in the material itself or in the operating environment of the dishwasher 10. Further, the coating material 200 (e.g., an epoxy material or a sealant material) may have thermal properties suitable for such a dishwasher application, which may have, for example, the possibility of high or otherwise elevated operating temperatures. The coating material 200 (e.g., an epoxy material or sealant material) may also demonstrate desirable mechanical vibration resistance, and may further serve to reduce the risk of the winding 110/connectors 120 engagements (i.e., the interface/terminal junctions 140) from loosening over time. In one particular embodiment, a Dow-Corning silicone resin or RTV compound (UL® recognized QMFZ2) sealant material may be the coating material 200 used to provide at least some of these previously mentioned properties, though one skilled in the art will appreciate that many other suitable coating materials may be implemented in the alternative.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for the purposes of limitation.

That which is claimed:

1. A method of preventing galvanic corrosion in a pump motor for a dishwasher having a tub portion adapted to contain washing fluid therein, the dishwasher having a sump assembly disposed about a lower end of the tub portion for receiving the washing fluid therefrom, the method comprising:
operably engaging a pump assembly in fluid communication with the sump assembly, the pump assembly having a pump motor with a non-submersed winding terminating in and secured to at least one electrical connector about a non-submersed interface, the winding comprising a first metallic material and the electrical connector comprising a second metallic material different from the first metallic material; and
applying a coating material about the non-submersed interface between the winding and the electrical connector, so as to cover the securement therebetween, to prevent moisture from encroaching between the winding and the electrical connector and promoting galvanic corrosion between the dissimilar first and second metallic materials thereof.

2. A method according to claim 1 wherein operably engaging a pump assembly in fluid communication with the sump assembly further comprises operably engaging a pump assembly, having the first metallic material comprising an aluminum material, and the second metallic material comprising a non-aluminum metallic material, with the sump assembly.

3. A method according to claim 1 wherein operably engaging a pump assembly in fluid communication with the sump assembly further comprises operably engaging a pump assembly, having the first metallic material comprising an aluminum material, and the second metallic material comprising a brass material, with the sump assembly.

4. A method according to claim 1 wherein applying a coating material about the non-submersed interface between the winding and the electrical connector further comprises applying a coating material, comprising one of an epoxy material and a sealant material, configured to be at least one of moisture-resistant, heat-resistant, non-conductive, and resistant to mechanical vibration, about the non-submersed interface between the winding and the electrical connector.

5. A method according to claim 1 wherein operably engaging a pump assembly in fluid communication with the sump assembly further comprises operably engaging a pump assembly, comprising one of a drain pump assembly and a circulation pump assembly, with the sump assembly.

6. A method according to claim 1 wherein applying a coating material about the non-submersed interface between the winding and the electrical connector further comprises applying a coating material about the non-submersed interface such that the coating material secures the non-submersed winding in contact with the at least one electrical connector.

7. A method according to claim 1 wherein applying a coating material about the non-submersed interface between the winding and the electrical connector further comprises applying a coating material about the non-submersed interface, having the winding soldered to the at least one electrical connector, such that the coating material substantially encompasses the solder securing the non-submersed winding to the at least one electrical connector.

8. A dishwasher, comprising:
a tub portion having a lower end and being adapted to contain a washing fluid therein;
a sump assembly disposed about the lower end of the tub portion for receiving the washing fluid therefrom; and
a pump assembly in fluid communication with the sump assembly, the pump assembly having a pump motor with a non-submersed winding terminating in and secured to at least one electrical connector about a non-submersed interface, the winding comprising a first metallic material and the electrical connector comprising a second metallic material different from the first metallic material, the pump assembly having a coating material disposed about the non-submersed interface between the winding and the electrical connector, so as to cover the securement therebetween, to prevent moisture from encroaching between the winding and the electrical connector and promoting galvanic corrosion between the dissimilar first and second metallic materials thereof.

9. A dishwasher according to claim 8 wherein the first metallic material comprises an aluminum material, and the second metallic material comprises a non-aluminum metallic material.

10. A dishwasher according to claim 9 wherein the second metallic material comprises a brass material.

11. A dishwasher according to claim 8 wherein the coating material comprises one of an epoxy material and a sealant material, and the coating material is configured to be at least one of moisture-resistant, heat-resistant, non-conductive, and resistant to mechanical vibration.

12. A dishwasher according to claim 8 wherein the pump assembly comprises one of a drain pump assembly and a circulation pump assembly.

13. A dishwasher according to claim 8 wherein the coating material is configured to secure the non-submersed winding in contact with the at least one electrical connector.

14. A dishwasher according to claim 8 wherein the non-submersed winding is soldered to the at least one electrical connector, and the coating material is configured to substantially encompassing the solder securing the non-submersed winding to the at least one electrical connector.

15. A pump assembly, comprising:
a pump motor with a non-submersible winding terminating in and secured to at least one electrical connector about a non-submersible interface, the winding comprising a first metallic material and the electrical connector comprising a second metallic material different from the first metallic material; and
a coating material disposed about the non-submersible interface between the winding and the electrical connector, so as to cover the securement therebetween, to prevent moisture from encroaching between the winding and the electrical connector and promoting galvanic corrosion between the dissimilar first and second metallic materials thereof.

16. A pump assembly according to claim 15 wherein the first metallic material comprises an aluminum material, and the second metallic material comprises a non-aluminum metallic material.

17. A pump assembly according to claim 16 wherein the second metallic material comprises a brass material.

18. A pump assembly according to claim 15 wherein the coating material comprises one of an epoxy material and a sealant material, and the coating material is configured to be at least one of moisture-resistant, heat-resistant, non-conductive, and resistant to mechanical vibration.

19. A pump assembly according to claim 15 wherein the coating material is configured to secure the non-submersible winding in contact with the at least one electrical connector.

20. A pump assembly according to claim 15 wherein the non-submersible winding is soldered to the at least one electrical connector, and the coating material is configured to substantially encompassing the solder securing the non-submersible winding to the at least one electrical connector.
